(19) United States
(12) Patent Application Publication
(10) Pub. No.: US 2005/0257522 A1
(43) Pub. Date: Nov. 24, 2005

(54) Turbocharger

(76) Inventors: Johan K. Fremerey, Bonn (DE); Hermann Stelzer, Aachen (DE); Jens-Wolf Jaisle, Stuttgart (DE)

Correspondence Address: CLARK & BRODY, 1090 VERMONT AVENUE, NW, SUITE 250, WASHINGTON, DC, 20005, US

(21) Appl. No.: 11/130,158

(22) Filed: May 17, 2005

(30) Foreign Application Priority Data
May 18, 2004 (DE) 102004025049.9-13

(51) Int. Cl. F02D 23/00; F02B 33/44

(52) U.S. Cl. 60/605.3; 60/605.1

(57) ABSTRACT

A turbocharger comprises a shaft connecting a turbine wheel, which is disposed in a turbine housing, to an impeller wheel. Between the two is a bearing system having a bearing housing and bearings for the shaft disposed therein. The shaft is fitted with at least one heat insulation between the turbine wheel and the bearing system, of which the heat conductivity is lower than that of the portions of the shaft which are adjoining said insulation and which hampers heat transmission through the shaft.

The present invention relates to an exhaust-gas driven turbocharger, comprising a shaft connecting a turbine wheel mounted in a turbine housing to an impeller wheel, further a bearing system located therebetween with a bearing housing which encloses shaft bearings.

Turbochargers improve efficiency and hence the output of internal combustion engines. They comprise a shaft which at one end is fitted with a turbine wheel and at the other end with an impeller wheel. The turbine wheel is loaded by a flow of exhaust gas from the internal combustion engine and basically the exhaust gas heat energy is thereby converted by the turbine wheel into rotation. The impeller is driven by the shaft and draws in fresh air which flows at higher pressure into the internal combustion engine's intake ducts, the rate of filling being improved in this manner.

The bearing system of turbocharger shafts must meet high requirements. On one hand this shaft is subjected to high rotational speeds up to 300,000 rpm. On the other hand the turbocharger is exposed by the exhaust gas flow at the turbine side to high temperatures which, in spark-ignition engines, may exceed even 1,000° C., whereas the temperature at the compressor side in general is no more than 150° C. It is clear therefore that the bearings on the turbine side are subjected to enormous thermal stresses.

As regards journal or ball bearings, temperatures of this magnitude foremost endanger the oil circulation. When critical temperatures are exceeded, oil residues will form in the form of carbon deposits which in fairly short time, on account of shaft seizure, entail turbocharger failure. In state of the art of spark engines the bearing system housing has a jacket of cooling water to keep the bearing housing temperature within appropriate limits. However, this feature renders the turbocharger more expensive.

Proposals have been made recently to replace the bearings used to date, namely journal or roller bearings, with magnetic bearings, and in this manner to guide the shaft in contactless manner (see for instance the German patent document DE 102 16 447 C1). Said magnetic bearings offer the advantage that they can be operated without lubricants and that as a result the above cause of failure is eliminated. On the other hand, the permanent magnets used for such purposes irreversibly lose their magnetic properties when heated to high temperatures.

Therefore it is the objective of the present invention to design a turbocharger of the initially cited kind in a manner that, using economical measures, heating of the bearing to a temperature degrading their operational reliability shall be averted.

This problem is solved by the present invention in that the shaft between the turbine wheel and the bearing system shall be fitted with at least one heat insulation of which the thermal conductivity is less than that of the shaft regions adjoining said insulation and which hampers heat from being transmitted through the shaft. This design feature is based on the insight that a substantial part of the heat generated at the turbine side is transmitted into the bearing system through the shaft. On account of said heat insulation, heat transfer to the bearing system is lowered by appropriately selecting the thermal insulation and its dimensioning to meet the particular requirements.

In an embodiment of the invention, the heat insulation includes an insulating layer covering the shaft cross-section, this layer exhibiting a lower thermal conductivity than the shaft material. This insulating layer must be able to withstand the temperatures it is subjected to and moreover the shaft may not be unduly weakened mechanically. Especially suited, for reasons of mechanical strength, are metals having a thermal conductivity which is lower, in particular considerably lower, than that of the material of the remaining shaft portion, usually a steel. Metals which are suited to be used for the insulating layer are in particular nickel-chromium alloys, for instance those known by their tradenames INCONEL® and INCOLOY®, though high-grade steel alloys also are suitable.

Instead of or in combination with an insulating layer, the heat insulation also may comprise a zone of reduced cross-sectional shaft area in order to hamper in this manner the transfer of heat. This may for instance be implemented by forming a cavity in the shaft, where said cavity moreover may extend over the full shaft length, so that a hollow shaft is provided.

Alternatively to or in combination with the above cited measures, the problem of the present invention also may be solved in that the shaft portion between the turbine wheel and the bearing system and/or the bearing housing has or have additional heat transfer surfaces. These additional heat transfer surfaces improve heat dissipation into the environment. Said heat transfer surfaces may for instance be formed as at least one cooling disk mounted on the shaft.

Alternatively to or in combination with the above cited measures, the problem of the present invention also may be solved in that the flanges connecting the bearing housing and the turbine housing are provided with a thermal insulation having a thermal conductivity that is smaller than that of the flanges as such. In this manner the heat transfer effected by thermal conduction through the housings may be reduced.

The simplest way to carry this out is that said thermal insulation comprises an insulating layer having a thermal conductivity which is smaller than that of the flange material as such, said layer being disposed between the flanges. As in the case of the heat insulation of the shaft, the insulating layer may be a metal, for instance a nickel-chromium alloy or a high-grade steel alloy. However, other poorly thermally conducting materials, for instance minerals or ceramics, may also be used.

The thermal insulation may comprise insulating ridges instead of or in combination with an insulating layer, by means of which ridges the flanges of the flange connection abut each other. This design is based on the concept of minimizing the surfaces by which the flanges contact one another. The insulating ridges may be designed in a manner to enclose a cavity which may optionally be filled with an insulating material.

A further measure for solving the problem of the present invention is to provide an external coating at least partly covering the turbine housing and/or the bearing housing in order to improve heat dissipation into the environment. This measure may also be combined with the above described measures in order to enhance the protection of the bearing against thermal stresses. The thermal conductivity of this coating may be higher than that of the material constituting the turbine or bearing housing, respectively. For example, the surface may be aluminium coated by means of flame spraying. Alternatively or in combination, said coating should be more thermally emissive than the material of the turbine or bearing housing, respectively.

A last measure for solving the problem of the present invention consists in coating at least partly the interior surface of the turbine housing in order to thereby decrease the heat absorbed by it. The heat absorptivity of the coating should be less than that of the material of the turbine housing. This measure reduces the heat absorption of the housing.

The present invention is elucidated by embodiments schematically shown in the drawing, in which

FIG. 1 is a longitudinal section of a turbocharger,

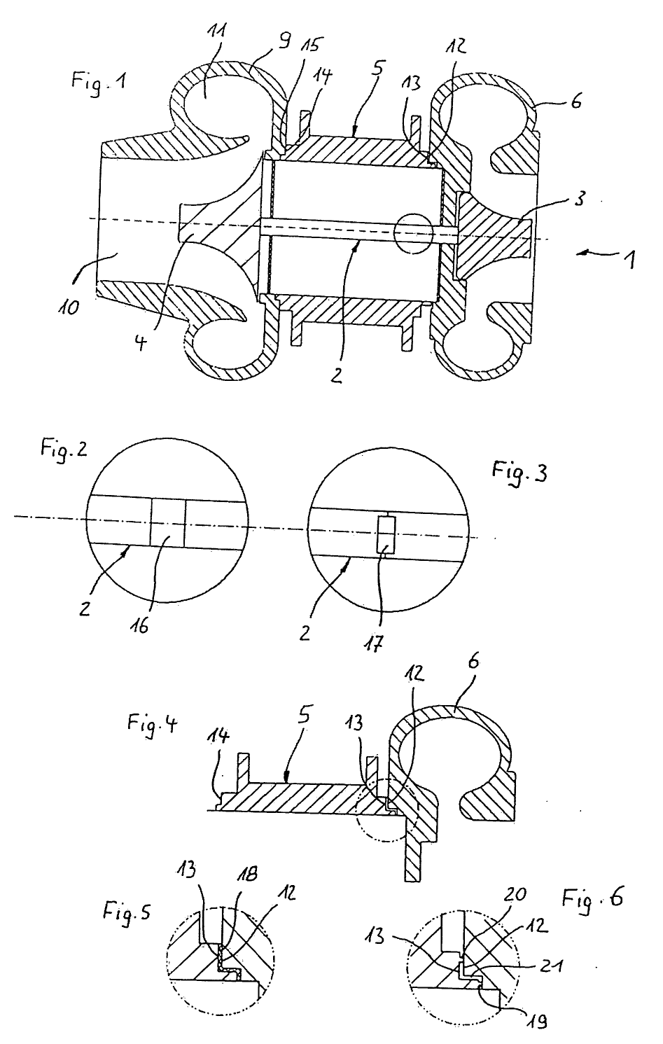

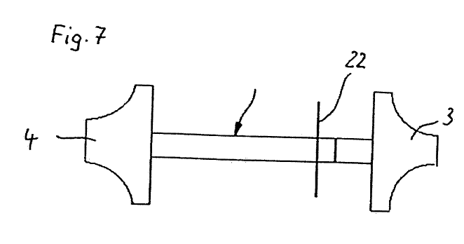

FIG. 2 is a detail of the turbocharger shaft of FIG. 1 in side view,

FIG. 3 is a further shaft detail of the turbocharger of FIG. 1 in side view,

FIG. 4 is a longitudinal section of a housing portion of the turbocharger of FIG. 1,

FIG. 5 is a longitudinal section of a detail of the housing portion of FIG. 4,

FIG. 6 is a longitudinal section of a further detail of the housing portion of FIG. 4, and

FIG. 7 is a side view of a turbine wheel and of an impeller wheel, connected by a shaft, of the turbocharger of FIG. 1.

The design of the turbocharger 1 shown in FIG. 1 is conventional. It comprises a shaft 2 on which are affixed a turbine wheel 3 on the right side and an impeller wheel 4 on the left side. In this case the shaft rests by means of omitted bearings in a tubular bearing housing 4. The bearings may be magnetic bearings such as those illustratively shown in the German patent document DE 102 16 447 C1.

The turbine wheel 3 is enclosed by a turbine housing 6 comprising an omitted radial intake aperture. The impeller wheel 4 is enclosed by a compressor housing 9 with a central intake aperture 10. Because of the rotation of the impeller wheel 4, air is drawn into this intake aperture and deflected into an annular space 11. This compressed air then exits the annular space 11 in the direction of the intake of the internal combustion engine through an outlet not shown in further detail here.

The turbine housing 6 and the impeller housing 9 are connected by pairs of flanges 12, 13 and 14, 15, respectively. The flanges 12, 13 and 14, 15, respectively, are conventionally tightened to each other by omitted screws.

FIG. 2. shows a details of the shaft near the turbine housing 6 and the turbine wheel 3, respectively. An intermediate piece 16 made of a nickel-chromium alloy, and therefore having a much lower thermal conductivity than the steel shaft 2, is welded into this shaft. The intermediate piece 16 acts as an insulating layer and hampers conductive heat transfer toward the turbine wheel 3 and hence to the bearings in the bearing housing 5.

FIG. 3 shows another embodiment of a shaft detail disposed at the same place. In this case the shaft 2 is provided with a cavity 17 which reduces the cross-sectional area of the shaft 2 available for heat conduction to an outer annular zone and thereby hampers heat transmission.

FIG. 4 shows the upper part of the bearing housing 5 and of the adjoining turbine housing 6 in the absence of the shaft 2 and turbine wheel 3. FIG. 5 shows a detail, namely a variation of the flange connection between the bearing housing 5 and the turbine housing 6. An insulating layer 18 is disposed between the two flanges 12, 13 and reduces the heat transfer from the turbine housing 6 to the bearing housing 5.

The heat transfer between the flanges 12, 13 may also be hampered in that the mutual, abutting contact of the flanges 12, 13 takes place only at ridges 19, 20 as shown in detail in FIG. 6. The ridges 19, 20 extend annularly over the full circumference of the flanges 12, 13 and therefore enclose a cavity 21. The small cross-sectional area of the ridges 19, 21 hampers heat conduction from the flange 12, which is part of the turbine housing 6, to the flange 12 which belongs to the bearing housing 5.

FIG. 7 shows the shaft 2 together with the turbine wheel 3 and the impeller wheel 4 in the absence of any housing. A cooling disk 22 is affixed to and rotates jointly with the shaft 2. The cooling disk 22 enlarges the heat transfer surface to the environment and by its rotation assures a convection flow enhancing heat dissipation.

Moreover, the turbine housing 6 may comprise a coating on an exterior surface thereof which improves the heat transfer to the environment, in other words, said coating exhibits higher thermal conductivity and/or higher thermal emittivity than the material of the turbine housing 6. Additionally, the turbine housing 6 may be provided with a coating reducing heat absorption on its interior surface.

1. A turbocharger (1) comprising a shaft (2) connecting a turbine wheel (3), which is disposed in a turbine housing (6), to an impeller wheel and comprising between the two a bearing system having a bearing housing (5) and bearings for the shaft (2) disposed therein, characterized in that the shaft (2) is fitted with at least one heat insulation (16, 17) between the turbine wheel (3) and the bearing system, of which the heat conductivity is lower than that of the portions of the shaft (2) which are adjoining said insulation and which hampers heat transmission through the shaft (2).

2. Turbocharger as claimed in claim 1, characterized in that the heat insulation includes an insulating layer (16) extending over the cross-section of the shaft (2) and exhibiting a heat conductivity lower than that of the material of the shaft (2).

3. Turbocharger as claimed in claim 2, characterized in that the insulating layer (16) is made of a metal.

4. Turbocharger as claimed in claim 3, characterized in that the metal is a nickel-chromium alloy or a high-grade steel alloy.

5. Turbocharger as claimed in claim 1, characterized in that the heat insulation (17) comprises a region where the cross-sectional area of the shaft (2) is reduced.

6. Turbocharger as claimed in claim 5, characterized in that the cross-sectional area of the shaft (2) is reduced by a cavity (17) formed in the shaft (2).

7. A turbocharger (1) comprising a shaft (2) connecting a turbine wheel (3), which is disposed in a turbine housing (6), to an impeller wheel and comprising between the two a bearing system having a bearing housing (5) and bearings for the shaft (2) disposed therein, characterized in that the shaft comprises additional heat transfer surfaces (22) between the turbine wheel (3) and the bearing system.

8. Turbocharger as claimed in claim 7, characterized in that the heat transfer surfaces are designed as a least one cooling disk (22) mounted on the shaft.

9. Turbocharger as claimed in claim 7, characterized in that the heat transfer surfaces (22) receive an incident flow of cooling gas which is branched off the compressor side of the turbocharger (1).

10. A turbocharger (1) comprising a shaft (2) connecting a turbine wheel (3), which is disposed in a turbine housing (6), to an impeller wheel (4) and comprising between the two a bearing system having a bearing housing (5) bearings for the shaft (2) disposed therein, the bearing housing (5) and the turbine housing (6) being connected to each other by flanges (12, 13), characterized in that the flanges (12, 13) are fitted with a thermal insulation (18, 19, 20), the thermal conductivity of which is lower than that of the flanges (12, 13).

11. Turbocharger as claimed in claim 10, characterized in that the thermal insulation includes an insulating layer (18), the thermal conductivity of which is lower than that of the material the flanges (12, 13) consist of.

12. Turbocharger as claimed in claim 11, characterized in that the insulating layer (18) is made of a metal.

13. Turbocharger as claimed in claim 12, characterized in that the metal is a nickel-chromium alloy or a high-grade steel alloy.

14. Turbocharger as claimed in claim 10, characterized in that the thermal insulation comprises insulating ridges (19, 20) by means of which the flanges (12, 13) of the flange connection abut each other.

15. Turbocharger as claimed in claim 14, characterized in that the insulating ridges (19, 20) enclose at least one cavity (21).

16. A turbocharger (1) comprising a shaft (2) connecting a turbine wheel (3), which is disposed in a turbine housing (6), to an impeller wheel and comprising between the two a bearing system having a bearing housing (5) and bearings for the shaft (2) disposed therein, characterized in that the turbine housing (6) and/or the bearing housing (5) are provided on their exterior at least partly with a coating which improves heat dissipation into the environment.

17. Turbocharger as claimed in claim 16, characterized in that the heat conductivity of the coating is higher than that of the material of the turbine housing (6) or the bearing housing (5).

18. Turbocharger as claimed in claim 16, characterized in that the coating exhibits a higher heat emittivity than the material of the turbine housing (6) or the bearing housing (5).

19. A turbocharger (1) comprising a shaft (2) connecting a turbine wheel (3), which is disposed in a turbine housing (6), to an impeller wheel and comprising between the two a bearing system having a bearing housing (5) and bearings for the shaft (2) disposed therein, characterized in that the interior surface of the turbine housing (6) is provided at least partly with a coating which reduces the heat absorption of the turbine housing (6).

20. Turbocharger as claimed in claim 19, characterized in that the coating has a lower heat absorptivity than the material of the turbine housing (6).

21. Turbocharger as claimed in claim 2, characterized in that the heat insulation (17) comprises a region where the cross-sectional area of the shaft (2) is reduced.

22. Turbocharger as claimed in claim 3, characterized in that the heat insulation (17) comprises a region where the cross-sectional area of the shaft (2) is reduced.

23. Turbocharger as claimed in claim 4, characterized in that the heat insulation (17) comprises a region where the cross-sectional area of the shaft (2) is reduced.

24. Turbocharger as claimed in claim 8, characterized in that the heat transfer surfaces (22) receive an incident flow of cooling gas which is branched off the compressor side of the turbocharger (1).

25. Turbocharger as claimed in claim 11, characterized in that the thermal insulation comprises insulating ridges (19, 20) by means of which the flanges (12, 13) of the flange connection abut each other.

26. Turbocharger as claimed in claim 12, characterized in that the thermal insulation comprises insulating ridges (19, 20) by means of which the flanges (12, 13) of the flange connection abut each other.

27. Turbocharger as claimed in claim 13, characterized in that the thermal insulation comprises insulating ridges (19, 20) by means of which the flanges (12, 13) of the flange connection abut each other.

28. Turbocharger as claimed in claim 17, characterized in that the coating exhibits a higher heat emittivity than the material of the turbine housing (6) or the bearing housing (5).
